(19) United States
(12) Patent Application Publication
(10) Pub. No.: US 2026/0133294 A1
(43) Pub. Date: May 14, 2026

(54) LIDAR SYSTEM AND LIDAR SCANNING METHOD

(71) Applicant: INDUSTRIAL TECHNOLOGY RESEARCH INSTITUTE, Hsinchu (TW)

(72) Inventors: Chih Chun CHEN, Kaohsiung City (TW); Chia-Yu HU, Tainan City (TW); Yi-Chi LEE, Taichung City (TW); Shih-Ting LIN, Tainan City (TW)

(73) Assignee: INDUSTRIAL TECHNOLOGY RESEARCH INSTITUTE, Hsinchu (TW)

(21) Appl. No.: 18/978,440

(22) Filed: Dec. 12, 2024

(30) Foreign Application Priority Data
Nov. 13, 2024 (TW) 113143562

(51) Int. Cl. G01S 7/481; G01S 7/484; G01S 17/931

(52) U.S. Cl. CPC G01S 7/4817; G01S 7/4814; G01S 7/4816; G01S 7/484; G01S 17/931

(57) ABSTRACT

A LiDAR system and a LiDAR scanning method are provided by the present disclosure. The LiDAR scanning method includes, by a beam steering and splitting module, selectively steering and splitting a laser beam, and, by a light signal receiving module, receiving a reflecting beam corresponding to the laser beam and transforming the reflecting beam into a reflection signal. The LiDAR scanning method also includes, by a focus zone circuit module, receiving the reflection signal and selectively generating an activation pulse according to the reflection signal, and, by a control module, controlling the beam steering and splitting module to steer and split the laser beam, for respectively and simultaneously scanning a scanning range and a focus scanning range.

This application claims the benefit of Taiwan application Serial No. 113143562, filed November 13, 2024, the disclosure of which is incorporated by reference herein in its entirety.

### TECHNICAL FIELD

The disclosure relates to a LiDAR system and LiDAR scanning method, and to a LiDAR system and LiDAR scanning method with techniques of steering and splitting laser beam.

### BACKGROUND

Regarding conventional LiDAR, during scanning, if a focus scan is intended to be applied on the scanned target, additional components and scanning steps need to be employed. Such as, more laser sources or steering mirror sets need to be added to apply the focus scan on the target, additionally, which will increase the scanning time and cost. For example, the point cloud density of single frame of conventional LiDAR can be high as 10000 points, and, when the refreshing rate of the scanning frames is 20 FPS, and only single laser source and receiving module (no additional laser source and receiving module) are used for focus scanning, the refreshing rate of the scanning frames will be decrease to 10 FPS or lower, which decrease the scanning speed. Alternatively, without reducing the FPS of LiDAR scanning, applying the focus scanning range requires adding additional light sources and receiving modules, which number of added light sources and receiving modules will increase as demands, and additional costs will be significantly increased. Thus, there are needs for techniques of adding focus scanning range without affecting the scanning efficiency and increasing costs of components.

### SUMMARY

The disclosure is directed to techniques of LiDAR system and LiDAR scanning method, which use focus zone circuit module cooperating with beam steering and splitting module, to add focus scanning range according to the position of an object into a preset activation distance.

According to one embodiment, a LiDAR system includes a beam steering and splitting module. The beam steering and splitting module includes a laser transmitting unit configured to transmit at least one laser beam. The beam steering and splitting module also includes an optical steering unit configured to selectively steer and split the at least one laser beam. The LiDAR system also includes a light signal receiving module configured to receive at least one reflecting light corresponding to the at least one laser beam, and configured to transform the at least one reflecting light to at least one reflection signal. The LiDAR system also includes a focus zone circuit module coupled to the light signal receiving module. The focus zone circuit module includes a signal filtering unit configured to selectively generate at least one activation pulse according to the at least one reflection signal. The LiDAR system also includes a control module coupled to the beam steering and splitting module and the focus zone circuit module. The control module is configured to control the optical steering unit to steer and split the at least one laser beam while receiving the at least one activation pulse.

According to another embodiment, a LiDAR scanning method includes setting, by a control module, an activation distance of a scanning range and a focus scanning range, of a beam steering and splitting module. The LiDAR scanning method also includes controlling, by the control module, a laser transmitting unit of the beam steering and splitting module to transmit a laser beam for scanning the scanning range. The LiDAR scanning method also includes receiving, by a light signal receiving module, a reflecting light corresponding to the laser beam and transforming the reflecting light to a reflection signal. The LiDAR scanning method also includes generating, by a focus zone circuit module, an activation pulse selectively, according to the reflection signal. The LiDAR scanning method also includes controlling, by the control module, while receiving the activation pulse, an optical steering unit of the beam steering and splitting module to steer and split the laser beam, to scan the scanning range and the focus scanning range simultaneously. The scanning range is greater than the focus scanning range.

### BRIEF DESCRIPTION OF THE DRAWINGS

FIG. 1 shows a diagram illustrating the scanning range and the focus range of an example LiDAR system disposed on the vehicle, according to implementations of the present disclosure.

FIGS. 2A and 2B respectively show block diagrams illustrating the example LiDAR system, according to implementations of the present disclosure.

FIGS. 3A and 3B respectively show diagrams illustrating pulses of multiple signal in the example LiDAR system of FIGS. 2A and 2B.

FIG. 4 shows a flowchart illustrating the procedure of LiDAR scanning, according to implementations of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

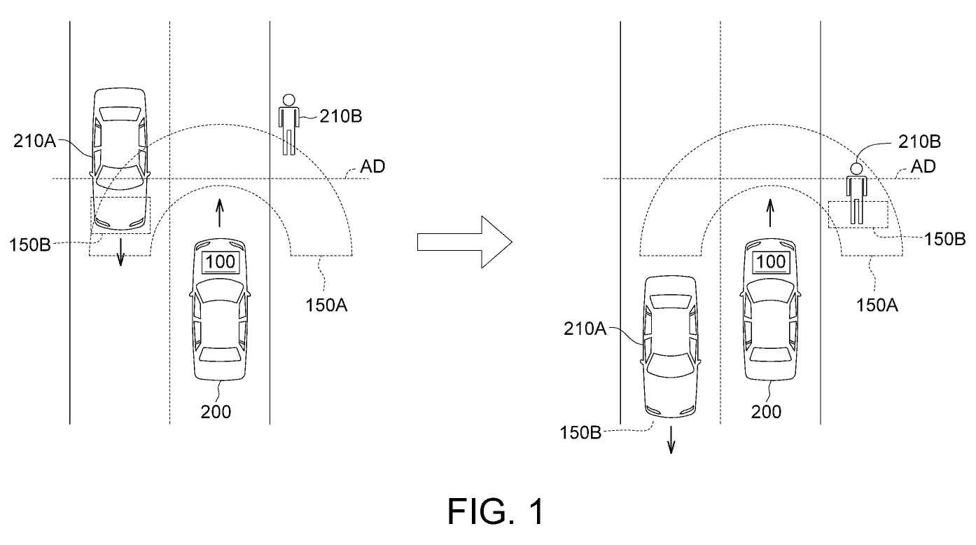

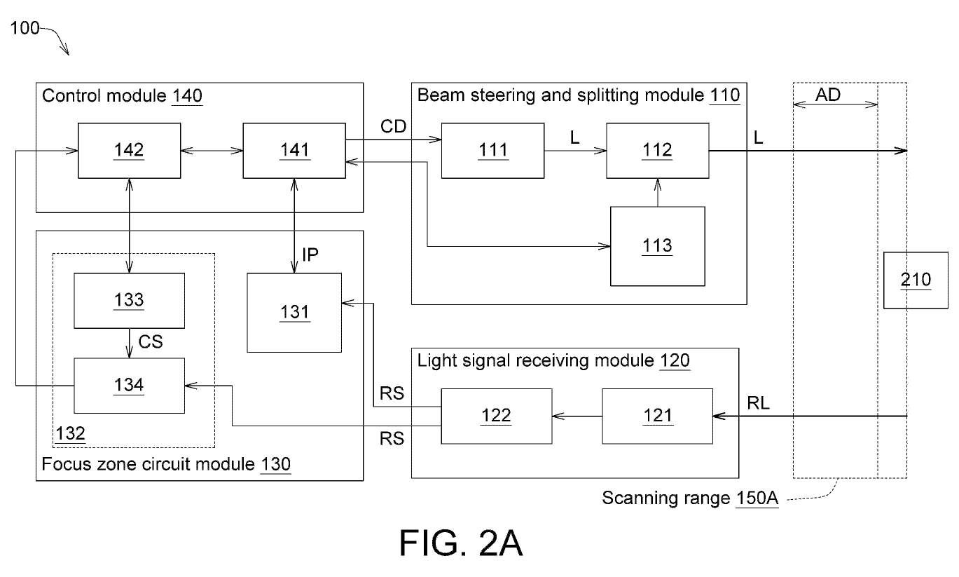

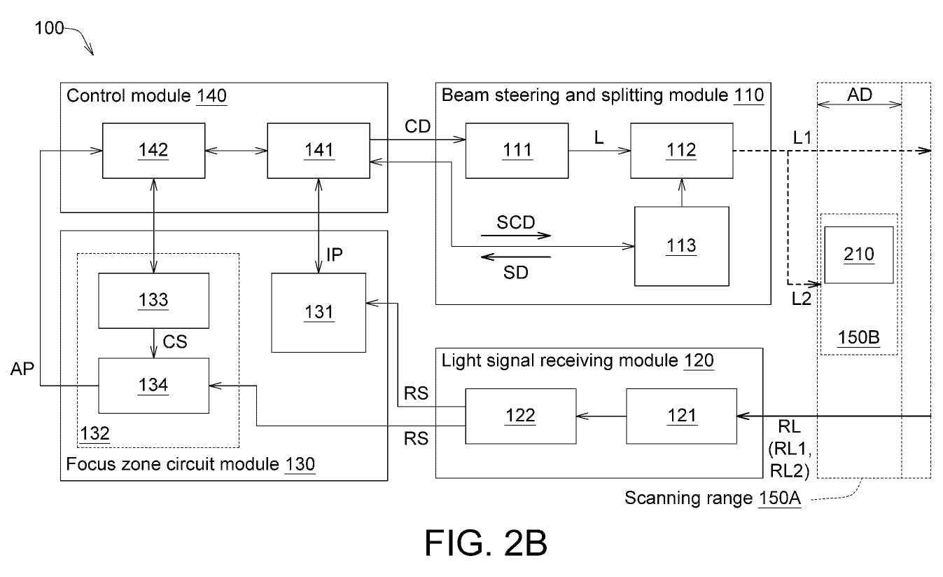

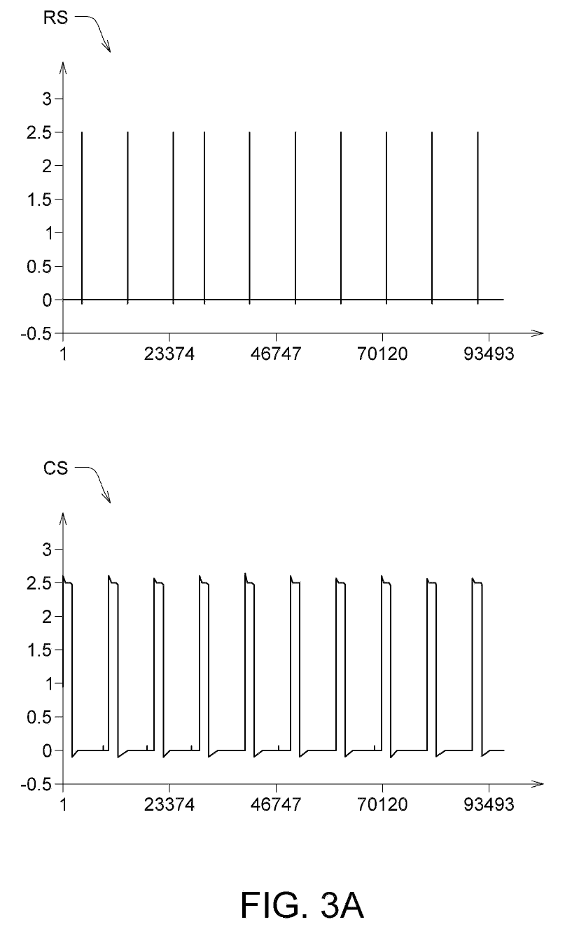

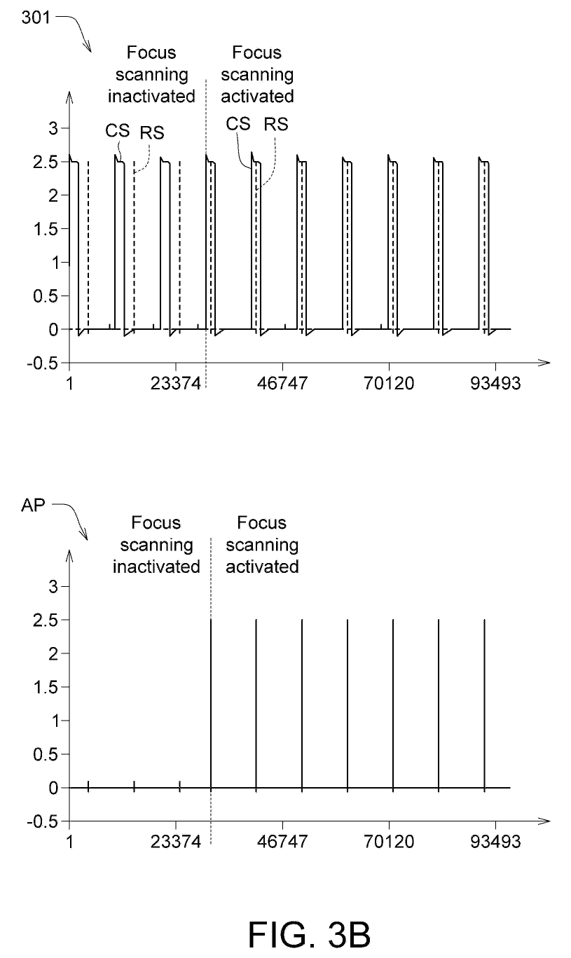

FIG. 1 shows a diagram illustrating the scanning range 150A and the focus scanning range 150B of an example LiDAR system 100 disposed on the vehicle 200, according to implementations of the present disclosure. As shown by FIG. 1, the LiDAR system 100 disposed on the vehicle 200, can scan the scanning range 150A in front of the vehicle 200 by a laser beam, for example. According to the techniques provided by implementations of the present disclosure, when the object 210, such as the object 210A (other vehicles) or the object 210B (pedestrian), is located within the preset activation distance AD, the LiDAR system 100 activates a beam steering and splitting function, to simultaneously scan the scanning range 150A and the focus scanning range 150B. When the object, such as the object 210A, vehicle, leaves the preset activation distance AD, the focus scanning range 150B will be removed. When other object, such as the object 210B, pedestrian, enters into the preset activation distance AD, the focus scanning range 150B will be activated again. The LiDAR system provided by implementations of the present disclosure will be detailed described referring to FIGS. 2A-3B as follows.

FIGS. 2A and 2B respectively show block diagrams illustrating the example LiDAR system 100, according to implementations of the present disclosure, and FIGS. 3A and 3B respectively show diagrams illustrating pulses of multiple signals (reflection signal RS and clock signal CS of FIG. 3A; the combination of the reflection signal RS and the clock signal CS, and activation pulse AP, of FIG. 3B) in the example LiDAR system 100 of FIGS. 2A and 2B. As shown by FIG. 2A, the LiDAR system 100 includes a beam steering and splitting module 110, a light signal receiving module 120, a focus zone circuit module 130 and a control module 140. Wherein, the light signal receiving module 120 is coupled to the focus zone circuit module 130, and the control module 140 is coupled to the beam steering and splitting module 110 and the focus zone circuit module 130. In this example, the control module 140 includes a first control unit 141 and a second control unit 142 coupled to the first control unit 141, wherein the first control unit 141 and the second control unit 142 are, but not limited to, two separated components. Such as for another example, the control module can be single controller perform all functions of the first control unit and the second control unit, as described herein.

The beam steering and splitting module 110 includes a laser transmitting unit 111 for transmitting at least one laser beam L, an optical steering unit 112 selectively steering and splitting the laser beam L, and an optical steering driving unit 113 driving the optical steering unit 112 to steer/split. In this example, the optical steering unit 112 and the optical steering driving unit 113 are, but not limited to, two separated components. In general operations, the first control unit 141 of the control module 140 can transmit the control data CD to the laser transmitting unit 111, such that the laser transmitting unit 111 generates the laser beam L for scanning the preset scanning range 150A. Additionally, the first control unit 141 can also preset the activation distance AD of the focus scanning range (such as the focus scanning range 150B of FIG. 1 or FIG. 2B). As discussed above, when the LiDAR system 100 detects that the distance between the object 210 and the vehicle 200 is less than the preset activation distance AD, the focus scanning range 150B can be activated.

The light signal receiving module 120 includes a photodiode 121 and a second amplifier 122. The photodiode 121 can be used for receiving the reflecting light RL corresponding to the laser beam L, and transforming the reflecting light RL to the reflection signal RS. Due to the techniques provided by the present disclosure, the laser beam L can be split (such as a first split light L1 and a second split light L2 of FIG. 2B, or more split lights corresponding to more focus scanning ranges 150B), which might decrease the strength of reflecting light and obtain the weaker reflection signal RS, and the reflection signal RS can be amplified by the second amplifier 122 and then output, which facilitates for processing signals in the post end. The reflection signal RS includes the reflection pulse, as shown by the pulse diagram of the reflection signal RS in the upper part of FIG. 3A.

The focus zone circuit module 130 includes a TDC (time to digital converter) unit 131 and a signal filtering unit 132. The TDC unit 131 can be used for receiving the reflection signal RS, and transforming the received reflection signal RS to digital transmission signal IP. The signal filtering unit 132 includes a clock signal generator 133 and a first amplifier 134, and can selectively generates the activation pulse AP. In general operations, the second control unit 142 of the control module 140 can set the clock signal generator 133 to generate respective clock signal CS according to the preset activation distance AD, such that the clock signal CS includes the clock pulse corresponding to the preset activation distance AD, as shown by the pulse diagram of the clock signal CS on the lower part of FIG. 3A. In some implementations, the control module 140 can set the clock frequency of the clock signal CS according to the laser frequency of the laser beam L, such that the clock frequency of the clock signal CS is identical the laser frequency of the laser beam L. The first amplifier 134 can compare the received clock signal CS with the received reflection signal RS, as shown by the pulse comparison 301 in the upper part of FIG. 3B. Since the clock pulse width of the clock signal CS is greater than the reflection pulse width of the reflection signal RS, during the comparison, the first amplifier 134 can determine to generate the activation pulse AP or not, if the reflection pulse of the reflection signal RS corresponds to the peak period of the clock pulse or not.

Such as in the case of FIG. 2A, since the object 210 is not located within the activation distance AD of the focus scanning range 150B, the reflection pulse of the reflection signal RS generated corresponding to the reflecting light RL, is not located in the peak period of the clock pulse of the clock signal CS, such as the first three reflection pulses/clock pulses of the reflection signal RS/the clock signal CS in the pulse comparison 301 in the upper part of FIG. 3B. In this case, the first amplifier 134 does not generate the activation pulse AP, and the control module 140 continuously control the laser transmitting unit 111 to transmit the laser beam L for scanning to the scanning range 150A.

Conversely, such as in the case of FIG. 2B, since the object 210 is located within the activation distance AD of the focus scanning range 150B, the reflection pulse of the reflection signal RS generated corresponding to the reflecting light RL, is located in the peak period of the clock pulse of the clock signal CS, such as starting at the fourth reflection pulse/clock pulse of the reflection signal RS/the clock signal CS in the pulse comparison 301 in the upper part of FIG. 3B. In this case, the first amplifier 134 correspondingly generates the activation pulse AP, as shown by the pulse diagram of the activation pulse AP in the lower part of FIG. 3B. When the second control unit 142 receives the activation pulse AP, it can be determined that the object 210 is located within the activation distance AD, and then the control module 140 can control the beam steering and splitting module 110 to activate the focus scanning range 150B.

Specifically, when the second control unit 142 receives the activation pulse AP, the first control unit 141 can be correspondingly informed, and obtain the position of the object 210, according to this time point, from the scanning of the scanning range 150A by the controlled laser beam L, as well as store the position of the object 210. Then, the first control unit 141 sets the focus scanning range 150B according to the position of the object 210, and steering control data SCD can be transmitted to the optical steering driving unit 113, such that the optical steering driving unit 113 drives the optical steering unit 112 to operate. In some implementations, the first control unit 141 can obtain status data SD from the optical steering driving unit 113, to obtain the driving states of the optical steering driving unit 113 driving the optical steering unit 112. The optical steering unit 112 can split the laser beam L to the first split light L1 and the second split light L2, such that, simultaneously, the first split light L1 can scan the scanning range 150A, and the second split light L2 can scan the focus scanning range 150B set by the position of the object 210. It can be understood that, the scanning range 150A is greater than the focus scanning range 150B, and scan path of the first split light L1 in the scanning range 150A can be identical or different to scan path of the second split light L2 in the focus scanning range 150B, such as one scan path is along the horizontal path while another one is along the vertical path, or both scan paths are along the horizontal path or the vertical path. After activating the focus scanning range 150B, the light signal receiving module 120 can receives a reflecting light RL1 and a reflecting light RL2 corresponding to the first split light L1 and the second split light L2. Based on the reflecting light RL1 and the reflecting light RL2, foresaid operations according to the reflecting light RL can be duplicated for determining whether any object enter into or leave the activation distance AD of the focus scanning range 150B, and the focus zone circuit module 130 can selectively generate the activation pulse AP by different scenarios, which the control module 140 can selectively (keeping) activating, removing or adding scanning of the focus scanning range 150B, such as by controlling the optical steering driving unit 113 of the beam steering and splitting module 110 driving or not driving the optical steering unit 112, to steer and split or stop steering and splitting the laser beam L, based on whether the activation pulse AP is received or not.

In some implementations, the first control unit 141 can receive the transmission pulse of the digital transmission signal IP from the TDC unit 131, and can obtain the time point, while the transmission pulse occurring, from the received digital transmission signal IP. The second control unit 142 controls the clock signal generator 133 of the signal filtering unit 132 to generate the clock signal CS, according to the time point of the first transmission pulse, of the digital transmission signal IP, occurring, such that the time point of the first clock pulse of the clock signal CS is corresponds the time point of the first transmission pulse, of the digital transmission signal IP, occurring. Consequently, it facilitates the first amplifier 134 comparing the clock signal CS (the clock pulse) with the digital transmission signal IP (the transmission pulse) without any time differences.

In the example of FIG. 2B, one focus scanning range 150B is added as an example, but not limited to. Such as for other examples, one or more focus scanning ranges 150B can be added due to one or more objects (such as object 210A or object 210B in FIG. 1) located within the preset activation distance AD of the focus scanning range 150B, which can be implemented, for example, by steering and splitting the laser beam L into more split lights.

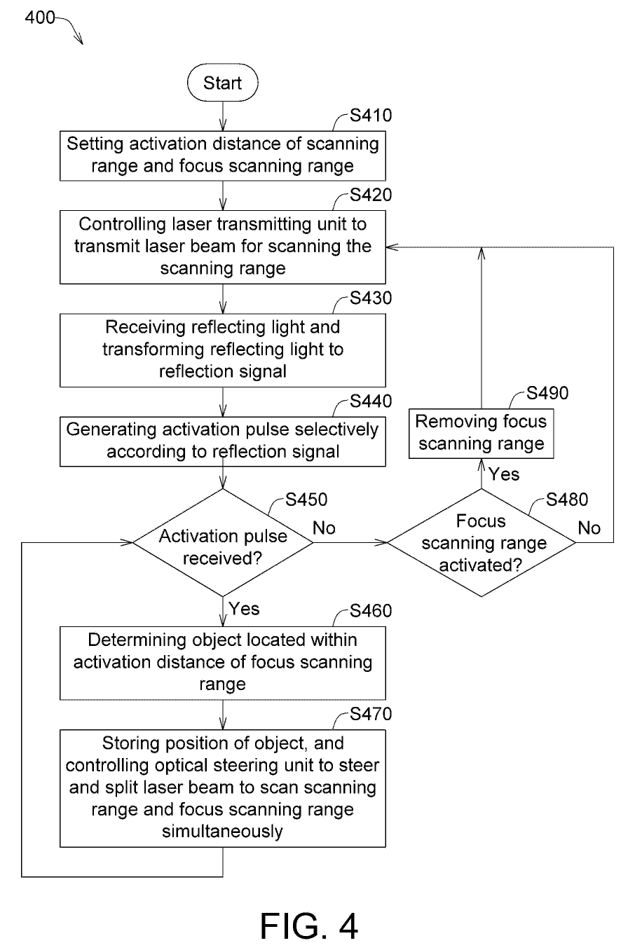

FIG. 4 shows a flowchart illustrating the procedure 400 of LiDAR scanning, according to implementations of the present disclosure. In step S410, a control module (such as the control module 140 of FIGS. 2A and 2B) for example, sets an activation distance of a scanning range and a focus scanning range (such as the scanning range 150A, the focus scanning range 150B and the activation distance AD of FIGS. 2A and 2B), of the beam steering and splitting module (such as the beam steering and splitting module 110 of FIGS. 2A and 2B). In step S420, the control module for example, controls a laser transmitting unit of the beam steering and splitting module to transmit a laser beam (such as the laser transmitting unit 111 and the laser beam L of FIGS. 2A and 2B) for scanning the scanning range. In step S430, a light signal receiving module (such as the light signal receiving module 120 of FIGS. 2A and 2B) for example, receives a reflecting light (such as the reflecting light RL of FIGS. 2A and 2B) corresponding to the laser beam and transforms the reflecting light to a reflection signal (such as the reflection signal RS of FIGS. 2A and 2B). In step S440, a focus zone circuit module (such as the focus zone circuit module 130 of FIGS. 2A and 2B) for example, generates an activation pulse (such as the activation pulse AP of FIGS. 2A and 2B) selectively, according to the reflection signal. In step S450, the control module for example, determines whether the activation pulse is received or not. In step S460, upon determining that the control module receives the activation pulse, the control module determines that an object is located within the activation distance of the focus scanning range. In step S470, the control module for example, stores the position of the object, and controls the optical steering unit (such as the optical steering unit 112 of FIGS. 2A and 2B) of the beam steering and splitting module to steer and split the laser beam, to scan the scanning range and the focus scanning range simultaneously, wherein the scanning range is greater than the focus scanning range. In step S480, upon determining that the control module does not receive the activation pulse, the control module determines whether the focus scanning range is activated. Upon determining that there is activated focus scanning range, goes to step S490, removing the activated focus scanning range, and goes back to step S420, only continuously scanning the scanning range; or upon determining that there is no activated focus scanning range in S480, directly goes back to step S420, only continuously scanning the scanning range.

In certain configurations, controlling the optical steering unit of the beam steering and splitting module to steer and split the laser beam comprises: driving, by an optical steering driving unit of the beam steering and splitting module, the optical steering unit to steer and split the laser beam, such that a first split light and a second split light, of the laser beam, respectively scan the scanning range and the focus scanning range, simultaneously. A first scan path of the first split light in the scanning range is different from a second scan path of the second split light in the focus scanning range.

In certain configurations, the focus zone circuit module selectively generating the activation pulse according to the reflection signal, comprises: generating, by a clock signal generator of a signal filtering unit, a clock signal with a clock pulse; receiving, by a first amplifier of the signal filtering unit, the reflection signal and the clock signal; outputting the activation pulse upon determining that a reflection pulse of the reflection signal corresponds to a peak period of the clock pulse; and removing any reflection pulse corresponding to a valley period of the clock pulse.

In certain configurations, the clock signal includes a clock frequency, and the laser beam includes a laser frequency. The clock frequency is identical to the laser frequency.

In certain configurations, the clock pulse includes a clock pulse width, and the reflection pulse includes a reflection pulse width. The clock pulse width is greater than the reflection pulse width.

In certain configurations, controlling the optical steering unit to steer and split the laser beam comprises: determining, by the control module, that an object is located within the activation distance of the focus scanning range; and storing, by the control module, a position of the object, and controlling the optical steering unit of the beam steering and splitting module to steer and split the laser beam, to simultaneously scan the scanning range and the focus scanning range corresponding to the position.

In certain configurations, the control module determining that the object is located within the activation distance of the focus scanning range, comprises: receiving, by a TDC unit the one reflection signal and transforming the reflection signal to a digital transmission signal with a transmission pulse; obtaining, by a first control unit of the control module, a first time point while the at least one transmission pulse occurring, from the TDC unit; and controlling, by a second control unit of the control module, the signal filtering unit to generate the clock signal according to the first time point. The first time point, while the at least one transmission pulse occurring, corresponds to a start time point of the clock pulse.

In certain configurations, the reflection pulse is identical to the transmission pulse.

In certain configurations, the procedure further comprises: sensing, by a photodiode of the light signal receiving module, the reflecting light and transforming the reflecting light to the reflection signal; and amplifying, by a second amplifier of the light signal receiving module, the reflection signal.

As described above, the techniques of LiDAR system and LiDAR scanning method provided by implementations of present disclosure, can use the focus zone circuit module cooperating with the beam steering and splitting module, to steer and split laser beam into split lights for simultaneously scanning on different paths, without generally affecting scanning speed of the LiDAR system. Also, the focus scanning range with higher accuracy can be automatically added, to monitoring the object, entering into the preset activation distance, with higher resolution (focus scanning). Adding the focus scanning range does not generally affect the scanning resolution and the scanning speed of the LiDAR system. Moreover, by splitting the laser beam and receiving the reflecting lights by the same light signal receiving module, there are no needs for installing additional laser beam transmitting module and additional light signal receiving module which can decrease the cost.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A LiDAR system, comprising:
a beam steering and splitting module, comprising:
a laser transmitting unit, configured to transmit at least one laser beam; and
an optical steering unit, configured to selectively steer and split the at least one laser beam;
a light signal receiving module, configured to receive at least one reflecting light corresponding to the at least one laser beam, and configured to transform the at least one reflecting light to at least one reflection signal;
a focus zone circuit module, coupled to the light signal receiving module, comprising:
a signal filtering unit, configured to selectively generate at least one activation pulse according to the at least one reflection signal; and
a control module, coupled to the beam steering and splitting module and the focus zone circuit module, the control module configured to control the optical steering unit to steer and split the at least one laser beam while receiving the at least one activation pulse.

2. The LiDAR system of claim 1, wherein the beam steering and splitting module further comprises a optical steering driving unit, configured to drive the optical steering unit to steer and split the at least one laser beam, such that a first split light and a second split light, of the at least one laser beam, respectively scan a scanning range and a focus scanning range, simultaneously,
wherein the scanning range is greater than the focus scanning range, and a first scan path of the first split light in the scanning range is different from a second scan path of the second split light in the focus scanning range.

3. The LiDAR system of claim 1, wherein the signal filtering unit comprises:
a clock signal generator, configured to generate a clock signal with a clock pulse; and
a first amplifier, coupled to the clock signal generator,
wherein the first amplifier is configured to output the at least one activation pulse upon determining that any reflection pulse, among at least one reflection pulse of the at least one reflection signal, corresponds to a peak period of the clock pulse, and remove any reflection pulse, among the at least one reflection pulse, corresponding to a valley period of the clock pulse.

4. The LiDAR system of claim 3, wherein the clock signal includes a clock frequency, and each of the at least one laser beam includes a laser frequency,
wherein the clock frequency is identical to the laser frequency.

5. The LiDAR system of claim 3, wherein the clock pulse includes a clock pulse width, and each of the at least one reflection pulse includes a reflection pulse width,
wherein the clock pulse width is greater than the reflection pulse width.

6. The LiDAR system of claim 3, wherein the focus zone circuit module further comprises a TDC (time to digital converter) unit, configured to receive the at least one reflection signal and transform the at least one reflection signal to at least one digital transmission signal.

7. The LiDAR system of claim 6, wherein the at least one digital transmission signal respectively includes at least one transmission pulse, and the at least one reflection pulse is identical to the at least one transmission pulse.

8. The LiDAR system of claim 7, wherein the control module comprises a first control unit and a second control unit coupled to the first control unit,
wherein the first control unit is coupled to the TDC unit and configured to obtain a first time point while the at least one transmission pulse occurring,
wherein the second control unit controls the signal filtering unit to generate the clock signal according to the first time point,
wherein the first time point, while the at least one transmission pulse occurring, corresponds to a start time point of the clock pulse.

9. The LiDAR system of claim 1, wherein the light signal receiving module comprises a photodiode and a second amplifier,
wherein the photodiode is configured to sense the at least one reflecting light and transform the at least one reflecting light to the at least one reflection signal, and the second amplifier is coupled to the photodiode and configured to amplify the at least one reflection signal.

10. A LiDAR scanning method, comprising:
setting, by a control module, an activation distance of a scanning range and a focus scanning range, of a beam steering and splitting module;
controlling, by the control module, a laser transmitting unit of the beam steering and splitting module to transmit a laser beam for scanning the scanning range;
receiving, by a light signal receiving module, a reflecting light corresponding to the laser beam and transforming the reflecting light to a reflection signal;
generating, by a focus zone circuit module, an activation pulse selectively, according to the reflection signal; and
controlling, by the control module, while receiving the activation pulse, an optical steering unit of the beam steering and splitting module to steer and split the laser beam, to scan the scanning range and the focus scanning range simultaneously,
wherein the scanning range is greater than the focus scanning range.

11. The LiDAR scanning method of claim 10, wherein controlling the optical steering unit of the beam steering and splitting module to steer and split the laser beam comprises:
driving, by an optical steering driving unit of the beam steering and splitting module, the optical steering unit to steer and split the laser beam, such that a first split light and a second split light, of the laser beam, respectively scan the scanning range and the focus scanning range, simultaneously,
wherein a first scan path of the first split light in the scanning range is different from a second scan path of the second split light in the focus scanning range.

12. The LiDAR scanning method of claim 10, wherein the focus zone circuit module selectively generating the activation pulse according to the reflection signal, comprises:
generating, by a clock signal generator of a signal filtering unit, a clock signal with a clock pulse;
receiving, by a first amplifier of the signal filtering unit, the reflection signal and the clock signal;
outputting the activation pulse upon determining that a reflection pulse of the reflection signal corresponds to a peak period of the clock pulse; and
removing any reflection pulse corresponding to a valley period of the clock pulse.

13. The LiDAR scanning method of claim 12, wherein the clock signal includes a clock frequency, and the laser beam includes a laser frequency,
wherein the clock frequency is identical to the laser frequency.

14. The LiDAR scanning method of claim 12, wherein the clock pulse includes a clock pulse width, and the reflection pulse includes a reflection pulse width,
wherein the clock pulse width is greater than the reflection pulse width.

15. The LiDAR scanning method of claim 14, wherein controlling the optical steering unit to steer and split the laser beam comprises:
determining, by the control module, that an object is located within the activation distance of the focus scanning range; and
storing, by the control module, a position of the object, and controlling the optical steering unit of the beam steering and splitting module to steer and split the laser beam, to simultaneously scan the scanning range and the focus scanning range corresponding to the position.

16. The LiDAR scanning method of claim 15, wherein the control module determining that the object is located within the activation distance of the focus scanning range, comprises:
receiving, by a TDC unit the one reflection signal and transforming the reflection signal to a digital transmission signal with a transmission pulse;
obtaining, by a first control unit of the control module, a first time point while the at least one transmission pulse occurring, from the TDC unit; and
controlling, by a second control unit of the control module, the signal filtering unit to generate the clock signal according to the first time point,
wherein the first time point, while the at least one transmission pulse occurring, corresponds to a start time point of the clock pulse.

17. The LiDAR scanning method of claim 16, wherein the reflection pulse is identical to the transmission pulse.

18. The LiDAR scanning method of claim 10, further comprising:
sensing, by a photodiode of the light signal receiving module, the reflecting light and transforming the reflecting light to the reflection signal; and
amplifying, by a second amplifier of the light signal receiving module, the reflection signal.
